(19) United States
(12) Patent Application Publication
(10) Pub. No.: US 2003/0132894 A1
(43) Pub. Date: Jul. 17, 2003

(54) Use of resonant microcavity display CRT for the illumination of a light valve projector

(76) Inventors: Eugene Murphy O'Donnell, Fishers, IN (US); Estill Thone Hall JR., Fishers, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/047,239

(22) Filed: Jan. 14, 2002

(51) Int. Cl. G09G 5/00

(52) U.S. Cl. 345/7

(57) ABSTRACT

The invention concerns an illumination source for a LCOS projection system. The illumination source is a cathode ray tube (CRT) that excites an array of phosphor based resonant microcavities. By selecting a uniform phosphor type for use in the array of resonant microcavities, the CRT can be designed to exclusively generate light of a selected color. The resonant microcavities can be arranged so that the light is projected through an LCOS device to produce an image. A projector lens can also be provided for magnifying and focusing the image for projection on a screen.

### BACKGROUND OF THE INVENTION

1. Field of the Invention

The present invention concerns projection displays and more particularly improvements in the illumination system for such displays.

2. Description of Related Art

Liquid crystal on silicon (LCOS) can be thought of an as one large liquid crystal formed on a silicon wafer. The silicon wafer is divided into an incremental array of tiny plate electrodes. A tiny incremental region of the liquid crystal is influenced by the electric field generated by each tiny plate and common electrode. Each such tiny plate and corresponding liquid crystal region are together referred to as a cell of the imager. Each cell corresponds to an individually controllable pixel. Each set of common and variable plate electrodes forms an image

The light supplied to the LCOS imager, and therefore supplied to each cell of the imager, is field polarized. Each liquid crystal cell rotates the polarization of the input light responsive to the root mean square (RMS) value of the electric field applied to the cell by the plate electrodes.

There are many techniques that can be used to create projection engines utilizing LCOS imagers. One method is to apply a digital signal to the imager so as to arrange the pixels in a configuration to form the image. In order to form the image, light from a light source passes through the pixels defined by the imager and bounces off a reflective surface of the opposing side. The reflected light exits the imager in the direction from which it originated. The reflected light goes through a lens that magnifies and focuses the image onto a screen.

An LCOS imager can be used to create a color display using a combination of three imagers. One method of creating such a color display makes use of a series of prisms that together form a cube. As the light enters the cube it is split into three beams, one of which is directed towards each of the three imagers. Each of the displays has a red, green or blue filter associated with it so that only one color is sent to each imager. Each imager is then driven with a digital signal associated with the correct image for its corresponding color. The red, green and blue light passes through a respective one of the imagers is then reflected back through the imager by a reflecting surface. The imager selectively changes the polarization of light passing through certain cells and such light is then either passed or blocked using an appropriate polarizing filter. The light that is allowed to pass forms an image. The images generated for each respective color are combined in the cube to create the final color image to be projected.

Currently, one of the major issues with projection displays such as LCOS is the lack of an adequate light source for illumination. The existing technology is inefficient, short lived, and requires major optical systems to transform the light into a usable form. The most common current solution to the foregoing problem is the high-pressure arc lamp. The high-pressure arc lamp has become the industry standard primarily because it is the only such lamp to have a reasonable lifetime. For example, a typical high-pressure arc lamp can average 10,000 hours.

Despite the advantages offered by the high-pressure arc lamp, they also possess a number of negative attributes. For example, they require a very small arc to make a sensible etendue (the product of radiant flux density and the area of a radiating or receiving surface). This implies a reduced lifetime for the light source and generally requires that the lamp bulb must be replaced several times over the life of the projection display.

Another significant disadvantage of the high-pressure arc lamp concerns the nature of the output produced. In particular, these light sources are inherently broadband in terms of spectral output. This means that in addition to primary color light (red, green, blue) that is useful for projection, the generated output will also contain unwanted components in the visible spectrum, as well as infrared and ultraviolet components. The inefficiencies of color filters used to process this light can also lead to broader band colors and therefore a smaller color space.

A further issue concerns the random or mixed polarization produced by high-pressure arc lamps. Non-CRT projection displays such as LCOS commonly require particular polarizations and it is therefore necessary to provide optical system components to be provided for polarization separation. Similarly, since the light coming from the lamps is essentially white, it is necessary to provide dedicated dichroic filters necessary to produce red, green, and blue light. In order to enhance the etendue, complex systems of integrators and collimators are also required to transform a focused beam into a uniform rectangular illumination. These additional components naturally increase the cost and complexity of such displays. They also increase the size and weight of the optical display. Finally, the wasted light energy inherent in such systems increases the heat generated by the projection system.

In an attempt to reduce the cost and complexity of such systems and improve image quality, it is desirable to provide a system that will avoid the problems of the prior art. Accordingly, there is a need in the art for a light source for non-CRT displays that generates less heat than existing systems that employ a high pressure arc lamp. There is a further need in the art for such a system in which the optical system is compact, highly reliable, and without the need for complicated light transmission paths.

Microcavity resonators, which can be incorporated in the present invention, have existed for some time. Microcavities are one example of a general structure that has the unique ability to control the decay rate, the directional characteristics and the frequency characteristics of luminescence centers located within them. The changes in the optical behavior of the luminescence centers involve modification of the fundamental mechanisms of spontaneous and stimulated emission. Physically, such structures as microcavities are optical resonant cavities with dimensions ranging from less than one wavelength of light up to tens of wavelengths. These have been typically formed as one integrated structure using thin-film technology. Microcavities involving planar, as well as hemispherical, reflectors have been constructed for laser applications.

The resonant microcavity display or resonant microcavity anode (RMA) is more fully described in U.S. Pat. Nos. 5,469,018 (to Jacobsen et. al), 5,804,919 (to Jacobsen et al), and U.S. Pat. No. 6,198,211 (to Jaffe et al), and in an article written by Jaffe et al entitled “Avionic Applications of Resonant Microcavity Anodes”, all hereby incorporated by reference. The controlled light output of an RMA utilizes a thin film phosphor inside a Fabry-Perot resonator. The structure of a monochrome RMA can consist of a faceplate having a thin film phosphor embedded inside a resonant microcavity. The references mentioned above clearly describe the benefits of using an RMA arrangement over a conventional CRT or FED arrangement using phosphor powders.

### BRIEF SUMMARY OF THE INVENTION

The invention concerns an illumination source for a LCOS projection system. The illumination source is a cathode ray tube (CRT) that excites an array of phosphor based resonant microcavities. By selecting a uniform phosphor type for use in the array of resonant microcavities, the CRT can be designed to exclusively generate light of a selected color.

According to one embodiment, the resonant microcavities can be arranged so that the light is projected through an LCOS device to produce an image. A projector lens can also be provided for magnifying and focusing the image for projection on a screen.

The invention also lends itself to a method for displaying an image. The method can include the steps of exciting the array of resonant microcavities for exclusively emitting light of the selected color and projecting the light through an LCOS imager defining a plurality of controllable pixels to produce an image. The image can be magnified and focused using a lens so that the image can be more readily projected on a screen. The method can also include optically combining the image produced with the light of the selected color with at least one other image of a second selected color distinct from the first selected color. In that case, the colors for the illumination source can be advantageously selected from the group consisting of red, green and blue to produce a full color picture.

According to an alternative aspect, the invention can comprise a projection type display unit. The display unit includes an imager, such as an LCOS device, having an array of controllable pixels. The unit also includes a light source for exclusively generating light of a selected color. The light source can be arranged for transmitting the light through the imager to produce an image that can be projected through a lens for magnifying and focusing the image. The light source is advantageously comprised of an array of resonant microcavities, each with an active region. The active region has a phosphor disposed therein for emitting light.

According to a preferred embodiment of the projection display unit, three imagers and three CRT devices can be provided. In that case, each of the CRT devices exclusively generates a distinct color of light for projection through a respective one of the imagers to produce three distinct color images. For example, the three CRT devices can produce red, green and blue light respectively. The system can also include an optical combiner for merging together each of the distinct color images to form a single composite image.

### BRIEF DESCRIPTION OF THE DRAWINGS

FIG. 1 is a drawing useful for illustrating the concept of a resonant microcavity array excited by a cathode ray tube.

FIG. 2 is a block diagram useful for illustrating how a resonant microcavity type CRT can be used as an illumination source for an LCOS display.

### DETAILED DESCRIPTION OF THE PREFERRED EMBODIMENTS

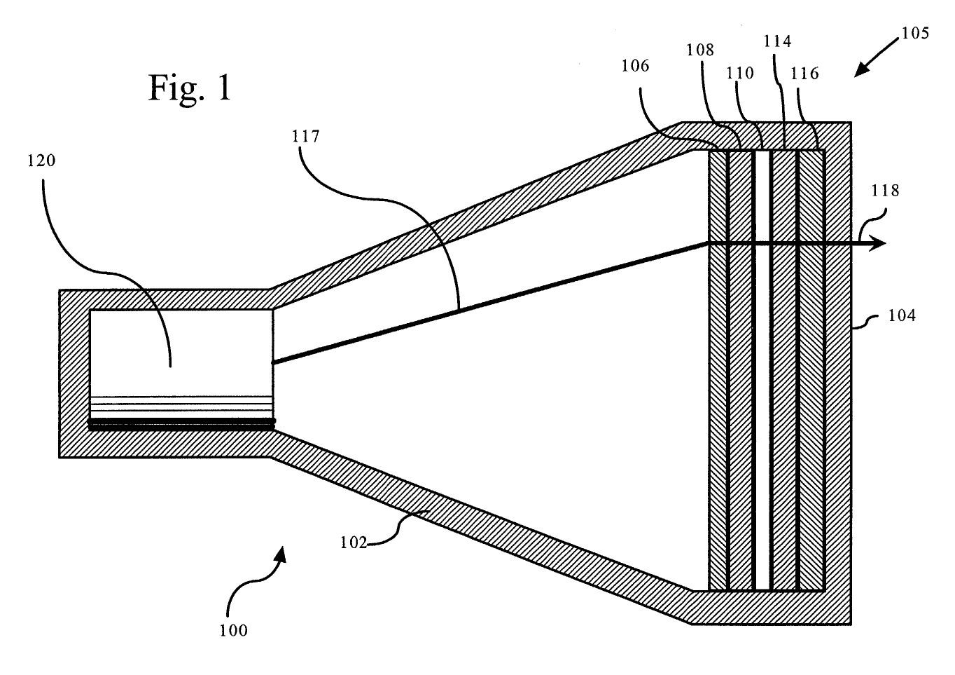

FIG. 1 is a diagram useful for understanding the operation of a CRT device 100 enhanced with an array of resonant microcavities. The CRT 100 is conventionally comprised of a glass vacuum tube 102 and an electron emitter 120 for producing an electron beam 117. The electron beam 117 is preferably directed toward a surface 104 of the vacuum tube opposing the electron emitter. The electron beam 117 can be scanned line-by-line to illuminate the pixels forming the phosphor based active region. Alternatively, since the CRT does not form an image directly, the electron beam can be more diffuse for concurrently illuminating a larger portion of the surface of the phosphor based active region.

A phosphor based resonant microcavity 105 is preferably provided inside the vacuum tube 102 at an end of the CRT 100 distal from the elecron emitter 120 and parallel to light emitting surface 104. The resonant microcavity 105 can advantageously be grown on a substrate 116. The resonant microcavity is comprised of a phosphor based active region 110 disposed between a front reflector 114 and a rear reflector 108.

For the purposes of the present invention, the phosphor is preferably selected to exclusively produce a single color light output 118. As is known in the art, the specific structure selected for the resonant microcavity can be comprised of various specific implementations in which various materials are used to form the resonant microcavity. A layer of aluminum 80 can be disposed next to the microcavity 105 to channel off electrons deposited by the electron emitter 120. The aluminum layer 80 can also serve as an additional reflecting surface to complement layer 108.

In FIG. 1, a planar mirror type resonant microcavity 105 is illustrated. However, those skilled in the art will appreciate that the invention is not intended to be so limited. For example, confocal mirror designs may also be used to form the resonator.

The use of resonant microcavities in a CRT is known. For example, the use of resonant microcavities is more fully described in U.S. Pat. Nos. 5,469,018 (to Jacobsen et. al), 5,804,919 (to Jacobsen et al), and U.S. Pat. No. 6,198,211 (to Jaffe et al), and in an article written by Jaffe et al entitled “Avionic Applications of Resonant Microcavity Anodes”, all hereby incorporated by reference. However, CRT type displays have generally been used in applications to directly produce an image using color phosphors. By comparison, the present invention makes use of CRT enhanced with a resonant microcavity array exclusively as a light source of selected wavelength having relatively high intensity and good spectral purity. In particular, the present invention makes use of such a CRT in an LCOS type display as shall hereinafter be described in greater detail.

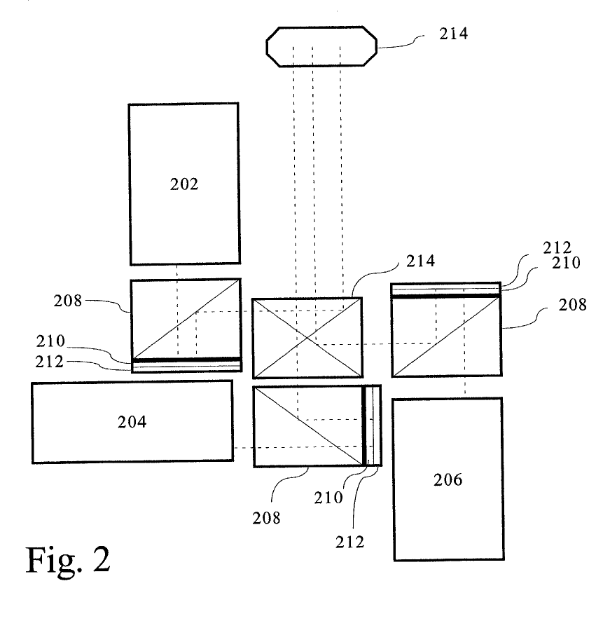

FIG. 2 is a block diagram of an LCOS projection display that is useful for illustrating the present invention. The invention is different from conventional LCOS displays that make use of high pressure arc lamps combined with color filters to produce light for an LCOS display. Instead, one or more resonant microcavity type CRT units 202, 204, 206 are arranged to directly produce light of a selected wavelenth and intensity. For example, in a preferred embodiment, each of the CRTs can be selected to produce one of red, green and blue light. Light produced by CRTs 202, 204, 206 passes through an associated polarizing beam splitter 208 provided for each CRT. Light passing through each of the polarizing beam splitters 208 is passed through a quarter wave plate 210 and through a respective LCOS imager to form an image. The light is reflected back through the LCOS imager 212 and is reflected as shown in each case by the polarizing beam splitter 208, toward the conventional crossed dichroic combiner 214. The crossed dichroic combiner combines the reflected images and directs them toward a projection lens 214.

The resonant microcavity enhanced CRT illumination source as described herein provides several significant advantages. For example, CRT units have considerably more useful life as compared to the high-pressure arc lamps, and they also generate less heat. Also, the present approach avoids the need for color filters for separating the illumination provided by the high-pressure arc lamp into red, green and blue. Finally, the light produced by the resonant microcavity enhanced CRT is of higher spectral purity as compared to that achievable using conventional color filtering techniques. This produces a considerably larger color space when using the inventive approach as described herein.

What is claimed is:

1. A projection type display unit, comprising,
an imager defining a plurality of controllable pixels;
a light source for exclusively generating light of a selected color, said light source arranged for transmitting said light through said imager to produce an image; and
a projector lens for magnifying and focusing said image for projection on a screen;
wherein said light source is comprised of a CRT device exciting a resonant microcavity with an active region, said active region having a phosphor disposed therein for exclusively emitting light of said selected color.

2. The projection display unit according to claim 1 wherein said imager is an LCOS device.

3. The projection display unit according to claim 1 wherein three said imagers are provided and three said CRT devices are provided, each of said CRT devices exclusively generating a distinct color of light for projection through a respective one of said imagers to produce three distinct color images.

4. The projection display unit according to claim 3 wherein said three CRT devices produce red, green and blue light respectively.

5. The projection display unit according to claim 4 further comprising an optical combiner, said optical combiner merging each of said distinct color images to form a single composite image.

6. An illumination source for a LCOS projection system, comprising:
a floodscreen cathode ray tube;
an array of resonant microcavities excited by said CRT for exclusively generating light of a selected color.

7. The illumination source according to claim 6 wherein said array of resonant microcavities is arranged so that said light is projected through an LCOS device to produce an image.

8. The illumination source according to claim 7 further comprising a projector lens for magnifying and focusing said image for projection on a screen.

9. A method for displaying an image, comprising,
exciting with a CRT an array of resonant microcavities configured for exclusively emitting light of a selected color;
projecting said light through an LCOS imager defining a plurality of controllable pixels to produce an image; and
magnifying and focusing said image through a lens for projection on a screen.

10. The method according to claim 9 further comprising the steps of:
optically combining said image produced with said light of said selected color with at least one other image of a second selected color distinct from said first selected color.

11. The method according to claim 10 wherein said colors are selected from the group consisting of red, green and blue.
